(19) United States
(12) Patent Application Publication
(10) Pub. No.: US 2012/0146327 A1
(43) Pub. Date: Jun. 14, 2012

(54) PIPE CONNECTION

(75) Inventor: JOHN Dawson WATTS, AUSTIN, TX (US)

(73) Assignee: BEVERLY WATTS RAMOS, AUSTIN, TX (US)

(21) Appl. No.: 13/324,892

(22) Filed: Dec. 13, 2011

Related U.S. Application Data
(60) Provisional application No. 61/422,894, filed on Dec. 14, 2010.

(51) Int. Cl. F16L 15/00

(52) U.S. Cl. 285/332

(57) ABSTRACT

Adjustment of stresses within a threaded connection having radial thread interference is taught by forming the box and pin threads on different axial pitches before assembly, so as to result in a preferred stress pattern after assembly. Also taught, is how to shape thread forms so as to avoid galling while connecting or disconnecting the box and pin.

This application claims priority on Provisional Patent Application 61,422,894 filed by applicant on 14 Dec. 2010 and references my co-pending U.S. patent application Ser. No. 12/087,762 filed 15 Jul. 5 2008 by applicant, both applications being included herein by reference.

### FIELD OF THE INVENTION

Oil Well Drilling Rigs have very high costs per day, so it is highly desirable that pipe threads stab and tighten easily without galling, to reduce costs and insure safety for the life of the well. As joints of pipe are being run into a well, each joint in turn is lowered to stab its pin into the box of the joint below, to be rotated and tightened so as to engage the threads to seal against fluids within the pipe and also support weight of thousands of feet of pipe in the hole below. If the pin and box threads do not engage smoothly when stabbed, they may gall and lock-up and stop short of the proper position for sealing and strength, which too often causes extremely expensive remedial work and injury if not caught before it is run in the hole, and if caught it can cost rig-time delays which run as high as $25,000/hr. It is therefore very important that pipe connections stab quickly and tighten without galling as enabled by the present invention, in any service where pipe threads are used, to enjoy similar advantages afforded in varying degrees of importance.

### BACKGROUND ART

Pipe threads such as API 5B 8-round and Buttress threads and virtually all proprietary thread forms, have radii that extend continuously between their flanks and crests to eliminate sharp corners that are not durable. As a tapered pin thread is lowered into a box having mating threads, pin thread crests slide on box thread crests with virtually no pressure between them until stab-position is reached, at which point, the pin crests are in contact with some portion of the 360 degrees of the box crests, thereby creating interface pressures between them that vary in accord with the relative rotational position. Often, the rotational position of the pin with respect to the box is such that line contact between the pin and box threads occur outside the minimum box crest diameter which does not cause the pipe weight to generate extreme pressures between the box and pin crests but when the rotational position of the pin does cause tangential line contact to occur near the box crest minimum diameter, the pressure angle between the crests can be great enough to cause galling and leakage through the threads, and even lock-up of the connection. Only one galled connection out of hundreds can cause failure and loss of the well.

Any tapered screw thread (pin) assembled in service with its mating internal thread (box) risks a mismatch of, and damage to both pin and box threads, especially when assembly must be done quickly under adverse conditions. If the starting point of the pin thread helix is positioned facing and adjacent the starting point of the box thread helix and if the threads are concentrically and axially aligned, then most of the box thread crest is in contact with the crest of the pin thread on a diameter greater than the minimum box thread diameter which favors an easy and fast start without damage, but the further away rotationally the starting points are from each other, the more apt that the pin thread crest will wedge radially between the box thread crest and create an excessive pressure angle at their mutual point of tangency which tends to gall, plastically deform, gouge, flake, shear and/or lock the threads together so as to defy disassembly and cause fluid leakage between the threads. Such damage still occurs on the crest radii between most pipe thread forms because extreme pressure angles can be formed between them. To improve the probability of an easy thread start, some operators mark both the pin and box end of the pipe relative to the thread helix starting point, and align the marks before stabbing a pin into a box to avoid galling, but wind, rain, urgency and other problems can foil such efforts, so a fail-safe feature is needed such as the present invention.

There are many examples in prior art of failed attempts to prevent such damage between screw threads such as: (1) Sharp-V pipe threads were replaced on tubing and casing by API 5B 8 Round and Buttress threads in 1939 which eliminated the sharp edge of the crest that allowed minute slivers of metal to tear off of the 120 degree corner angle between crest and flank, and cause galling between the mating threads, as they were tightened; and (2) U.S. Pat. No. 4,346,920 by Dailey in FIG. 3, best depicts a thread form having a wider crest but having an even smaller corner angle of 97 degrees between its load flank and crest, which increases damage. Dailey depicts a radius in the drawing that is not described or even mentioned in the patent, as evident in the enlarged reproduction of the radius on the Dailey patent thread form shown in FIG. 3. If it is assumed that the radius doesn't exist, then Dailey would suffer galling as described above on the Sharp V thread or if it is assumed that the radius does exist, then it will suffer the extreme pressure and galling as described above for the API 5B 8 Round thread.

Torques of typical tapered pipe connections are limited by hoop stresses in the box and pin as tightening progresses, so when it is required that a given connection withstand a higher torque without overstressing the box and pin, other features are required. One such feature used such as Slack Patent U.S. Pat. No. 6,899,356 B2, has been to place a ring in a coupling between the pin ends for them to exert force against to build torque after the pin has reached the desired makeup position, so as to not increase hoop stresses. However, force on the pin end together with the radial force from the coupling threads and the effect of Poisson's Ratio on the thread pitches, creates an increased biaxial compressive stress in the pin which if not then excessive, will be worsened when the pipe connection is subjected to external fluid pressure.

### SUMMARY OF THE INVENTION

The present invention is supplementary to my co-pending patent application '762, included herein by reference. Application '762 claims a general solution for thread galling and lock-up of pipe threads when a pin is within its mating box being connected or disconnected, and the present invention teaches removal of a specific small portion of the crest radii of the box and/or pin to prevent crests from contacting each other at extreme pressure angles. It is necessary to remove only the portion of the threads that can form an extreme pressure angle between the pin and box threads, which in some cases is less than a thousandth of an inch thickness.

The present invention also teaches how to desirably change stresses within a threaded connection upon assembly by changing thread pitches in the box and/or the pin: to reduce stresses between mating threads; to stress the pin compressively; and/or to stress the pin in tension to better adapt the threads to a given service.

### BRIEF DESCRIPTION OF THE DRAWINGS

FIG. 1. Depicts load flanks and crests of a connection and the arcuate surface between them, enlarged from FIG. 2 to show the thread form features in fine detail.

FIG. 2. Depicts a pipe connection per the present invention, having a coupling and two pins.

FIG. 3. An enlarged copy of radii labeled “r” in FIG. 3 of Dailey's U.S. Pat. No. 4,346,920.

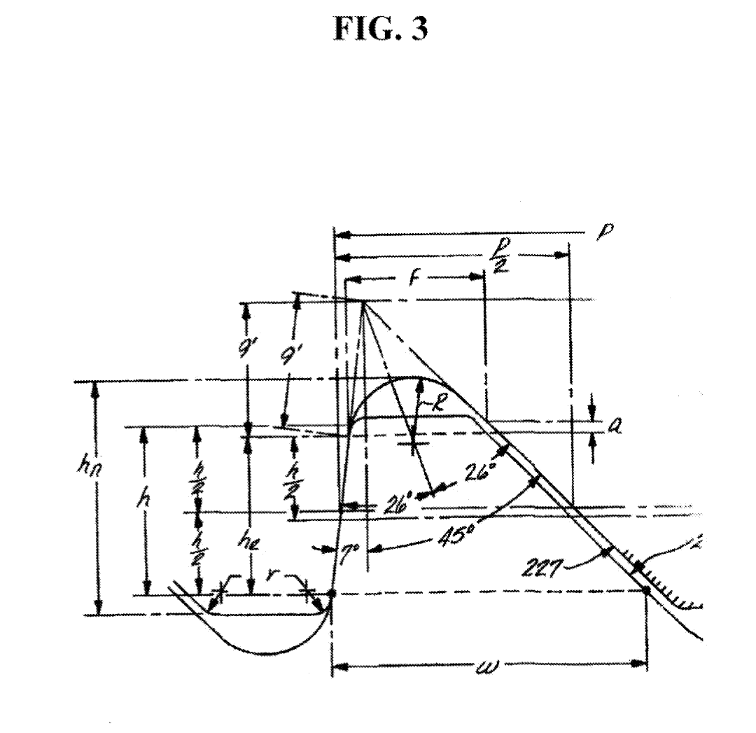

### DETAILED DESCRIPTION OF THE INVENTION

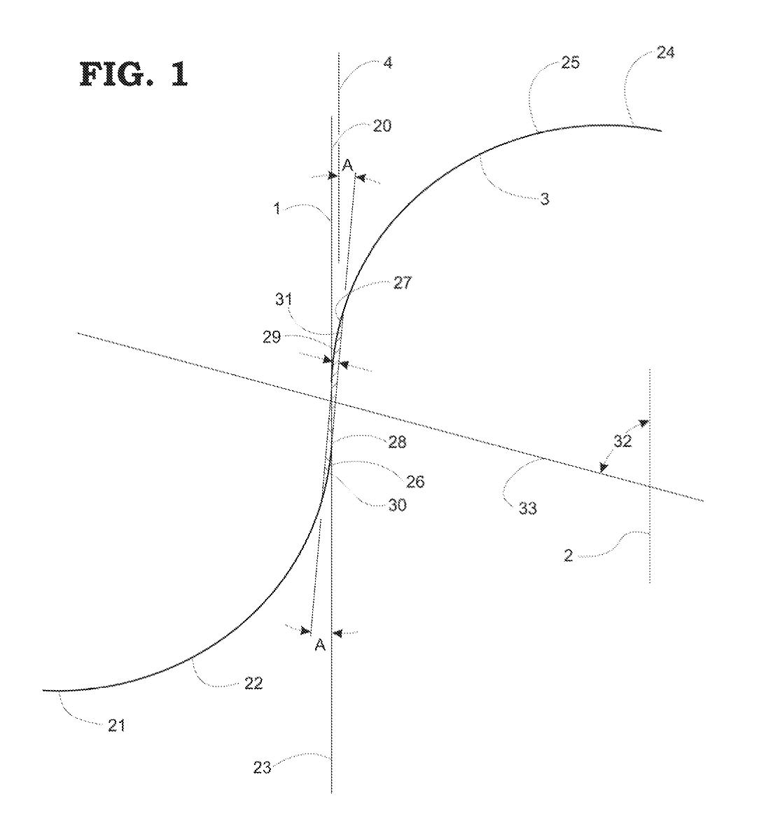

FIG. 1 is an enlarged detail of the present invention depicting a box thread crest (20), the adjacent box load flank (21) and a box thread surface (22) between them. Also depicted is a pin thread crest (23), a pin thread load flank (24) and a pin thread surface (25) between them. Whereas prior art has joined crests and flanks with continuous radii that allow extreme pressure angles to be formed between box and pin crest radii, the present invention teaches elimination of minute least diameter surfaces as at (26) and (27) of the box and pin radii adjacent the crest respectively, to preclude such extreme pressure angles being formed. Only a minute amount of material needs to be removed to effect the improvement, such as box and pin cross-hatched portions (28) and (29) respectively, whose removal leaves box and pin surfaces (30) and (31) respectively, shown formed on angle (A) relative to a line (4) parallel to the pipe axis (2). Angle (A) should exceed the proven angle of friction that exists between the mating threads so they will slide past one another easily without forming an extreme pressure angle between them and locking up.

The present invention teaches absence of a very small but very critical portion of the crests as shown by the cross-hatched portions of the box (28) and of the pin (29) to allow the pin thread to be lowered or raised to a position having enough contact between box and pin thread crests to provide instantaneous support for the pipe joint being installed and to permit smooth rotation while tightening the pin thread into the box thread without galling. Were the cross-hatched portions present and the pipe joints weight forced the pin into the box, then portions of the least diameter surfaces (26) and (27) would slide against each other and form an extreme pressure angle, perhaps as high as 89 degrees, causing a local bearing pressure between them in excess of the ultimate strength of the pipe material which would cause galling.

As described on page 4 lines 6-11 of the parent Application PCT/US07/001154 of my co-pending application '762, “During assembly of a threaded pipe connection, the pin is screwed into the box which generates an increasing radial interference between the mating threads, which reduces the pin diameter and increases the box diameter, and in accord with Poisson's Ratio the diameter changes elongate the pin axially and shorten the box axially, causing a lead mismatch between pin and box threads originally formed with equal lead. The degree of pitch mismatch depends on such as thread diameter, thread lead, radial interference, and on Poisson's Ratio for the pipe material.”

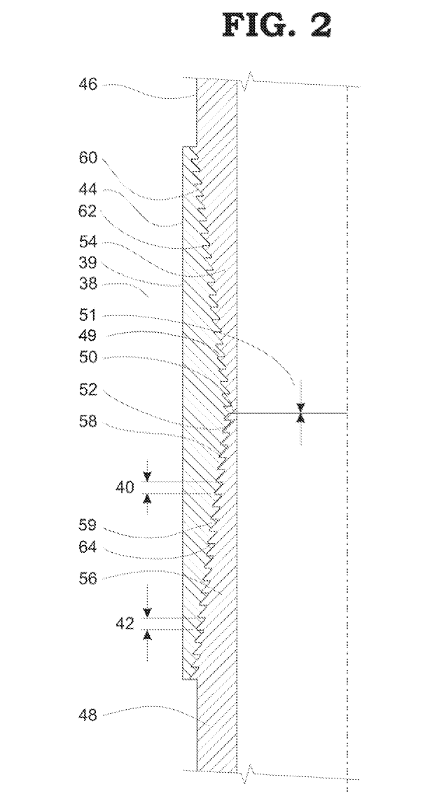

Another object of the present invention shown in FIG. 2 is to change the box thread pitch (40) and/or pin thread pitch (42) to be unequal so the assembled box (44) and pins (46,48) will have a specific stress pattern when axial and/or radial loads are imposed. As shown assembled, the pin ends (50,52) are tightened against each other as at (51) or through an intermediary member such as a ring, to load both pin ends in axial compression that combines with radial compression from the coupling to create even higher tri-axial compressive stresses in the pins toward mid-lengths (60,62) of the engaged threads (54,56), such that the pins are not apt to have enough stress reserve left at mid-length, to withstand external fluid pressures. The present invention teaches reduction of that compression stress to a safe level, or even changing it to tension, by changing the pitch of one or both threads. To accomplish a desirable stress pattern in accord with the present invention, the thread pitch of the box may be changed or the thread pitch of the pin may be changed or both, as may be best for each application, for instance: The pitches of the box and pin as machined may be chosen: As Case 1, to have equal pitch of the box and pin as assembled without axial stresses between the mating threads so they will accept loads as if they were one solid member by making the pin pitch less than the box pitch; or Case 2, have axial tension in the pin with compression in the box as assembled to enable the pin to withstand higher compression service loads by making the pin pitch even less; or Case 3, have compression in the pin with tension in the box as assembled by making the pin pitch equal or more than the box pitch, so the pin can withstand a higher tension service load as may best fit a given application. When an assembled pin is required to withstand excessive axially imposed compression loads as when pin ends contact upon makeup as describe above, in addition to the tangential compressive stress imposed by assembly and/or radial loads, then the tri-axial compressive stress in the pin may be lessened by reducing the pin thread pitch relative to the box thread pitch, so a substantial portion of the pin load will be transferred to the coupling through the engaged threads, short of the mid-lengths of thread engagement. Conversely, the pin pitch may be lengthened if necessary to reduce an imposed tension stress in the pin. Such a difference in box/pin thread pitch may be used to prevent relative axial movement between a mating box and pin, such as to prevent leakage of an API 5B buttress connection which now, as made with equal pitches, will pump the sealant out from between the box/pin threads upon reversal of axial loads on the connection. For maximum advantages, both axial and radial stresses should be evaluated before determining what pitch change(s) to make. The changes in pitches are small but easy to calculate using factors such as Poisson's Ratio, Young's Modulus, the allowable stress for the material, and the nominal thread pitch and the loads. The pitches are preferably measured across the most thread turns possible to improve accuracy.

I claim:

1. A tapered box thread (1) formed around an axis (2), the box thread having a crest (20), a load flank (21), a least diameter surface (26) on a box thread turn, a pressure line (33) positioned 90 degrees to surface (26), acute pressure angle (32) measured between the line and the axis, comprising: the pressure angle being not large enough to cause galling against a mating pin thread when the box and pin are assembled together.

2. A tapered pin thread (3) formed around an axis (2), the pin thread having a crest (23), a load flank (24), a least diameter surface (27) on a pin thread turn, a pressure line (33) positioned 90 degrees to surface (27), acute pressure angle (32) measured between the line and the axis, comprising: the pressure angle being not large enough to cause galling against a mating box thread when the pin and box are assembled together.

3. The box thread of claim 1 wherein the pressure angle is less than: 90 degrees minus the angle of friction between the threads.

4. The pin thread of claim 2 wherein the pressure angle is less than: 90 degrees minus the angle of friction between the threads.

5. A pipe connection (38) assembled with a coupling (39) and two pins (46,48), a box thread pitch (40) before assembly, a pin thread pitch (42) before assembly, the pins being made up tight in the coupling, the threads being dimensioned for radial interference, comprising: the thread pitches being dimensioned to effect a desired tri-axial stress pattern for the connection upon assembly, within the constraints of Poisson's Ratio, Young's modulus and yield strength of the connection material.

6. The pipe connection of claim 5, further comprising: the pin ends (50,52) directly or indirectly exerting compressive loads against each other which in turn load the pin threads (58,60) axially against coupling threads (49,59), mid-lengths of thread engagement of each pin being at (62,64), comprising: the pins threads made with a pitch sufficiently less than the pitch the box threads are made with, such that upon assembly together they transfer a desired portion of the compressive load to the coupling, within a predetermined thread length.

7. A pipe connection (38) assembled with a coupling (39) and two pins (46,48), a box thread pitch (40) before assembly, a pin thread pitch (42) before assembly, the pins being made up tight in the coupling, the threads being dimensioned for radial interference, comprising: the thread pitches being dimensioned to reduce the pin stress at mid-length of thread engagement to a predetermined value.

8. The pipe connection of claim 6, further comprising: The stress in the pin at mid-length of thread engagement being reduced to a predetermined value.

9. The box thread of claim 1, formed within a coupling (39), further comprising: a pin thread (60) formed on a pin (46), a coupling thread pitch (40) before assembly, a pin thread pitch (42) before assembly, the pin being made up tight in the coupling, the threads being dimensioned for radial interference, the thread pitches being dimensioned to effect a predetermined stress pattern within the coupling upon assembly, in accord with Poisson's Ratio, Young's modulus and material strength.

10. The pin thread of claim 2, formed on a pin (46) further comprising: a box thread (49) formed within a coupling (39), a coupling thread pitch (40) before assembly, a pin thread pitch (42) before assembly, the pin being made up tight in the coupling, the threads being dimensioned for radial interference, the thread pitches being dimensioned to effect a desired stress pattern in the pin upon assembly, in accord with Poisson's Ratio, Young's modulus and material strength.

11. The pipe connection of claim 5, further comprising: the pin thread pitches being longer than the box thread pitches sufficiently to preload the pins against relative axial movement with respect to the box.

12. The pipe connection of claim 5, further comprising: the pin thread pitches being sorter than the box thread pitches sufficiently to preload the pins against relative axial movement with respect to the box.
